(19) United States
(12) Patent Application Publication
(10) Pub. No.: US 2015/0039327 A1
(43) Pub. Date: Feb. 5, 2015

(54) SYSTEMS AND METHODS FOR MANAGING PATIENT RESEARCH DATA

(71) Applicant: Avik Kumar Pal, Fremont, CA (US)

(72) Inventor: Avik Kumar Pal, Fremont, CA (US)

(21) Appl. No.: 13/958,599

(22) Filed: Aug. 4, 2013

(51) Int. Cl. G06F 19/00; G06Q 50/22

(52) U.S. Cl. CPC G06F 19/363; G06Q 50/22
USPC 705/2

(57) ABSTRACT

The disclosure is directed to a process and system for managing the end-to-end process of obtaining research data from patients and/or participants in a Clinical Trial. The process enables collection of appropriate informed consent from patient/participants via electronic devices such as smart phones and tablets. Additionally, the system uses biometric information such as finger prints, face pictures, digital signature to provide additional information concerning a participant. This helps to make the whole informed consent process effortless, paperless and transparent. An aspect of the disclosure enables investigators to reach out to a wider patient/participant population irrespective of their physical location. Thus the platform enables investigators to collect and transfer real time data, seamlessly from across the world.

### CROSS REFERENCE TO RELATED APPLICATIONS

This application claims benefit of U.S. Provisional Application Ser. No. 61/680,203 filed on Aug. 6, 2012, entitled “SYSTEMS AND METHODS FOR MANAGING PATIENT RESEARCH DATA” and is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A clinical trial is a research study to answer specific questions about vaccines or new therapies or new ways of using known treatments. Clinical trials (also called medical research and research studies) are used to determine whether new drugs or treatments are both safe and effective. Data from the research study is submitted in support of an application for approval to sell the vaccines or new therapies for use on patients.

Carefully conducted clinical trials are the fastest and safest way to find treatments that work in patients. Trials typically fall into one of four phases: Phase 1 Clinical Trials are initial studies that are performed to determine the metabolism and pharmacologic actions of drugs in humans, the side effects associated with increasing doses, and to gain early evidence of effectiveness; may include healthy participants and/or patients. Phase 2 Clinical Trials are controlled clinical studies conducted to evaluate the effectiveness of the drug for a particular indication or indications in patients with the disease or condition under study and to determine the common short-term side effects and risks. Phase 3 Clinical Trials are expanded controlled and uncontrolled trials after preliminary evidence suggesting effectiveness of the drug has been obtained, and are intended to gather additional information to evaluate the overall benefit-risk relationship of the drug and provide and adequate basis for physician labeling. Phase 4 Clinical trials are post-marketing studies to delineate additional information including the drug's risks, benefits, and optimal use.

During the Clinical Trial, eligible patients are identified and informed consent is obtained from study participants. Informed consent is the process of a potential participant learning key facts about a clinical trial before deciding whether or not to participate. It is also a continuing process throughout the study to provide information for participants/patients in the clinical trial. To help someone decide whether or not to participate in a clinical trial, doctors and nurses involved in the clinical trial under the direction of the principal investigator (PI) conducting the clinical trial explain the details of the study. In obtaining informed consent of a participant, an informed consent document is prepared that describes the rights of the study participants, and includes details about the study, such as its purpose, duration, required procedures, and key contacts. Risks and potential benefits are explained in the informed consent document. The participant then decides whether or not to sign the document. Informed consent is not a contract, and the participant may withdraw from the trial at any time. Identification of eligible patients and obtaining informed consent from the patient is a time consuming process.

A New Drug Application (NDA) is an application submitted by the manufacturer of a drug to the U.S. Food and Drug Administration (FDA), after Phase 3 clinical trials have been completed, for a license to market the drug for a specified indication.

Premarket approval (PMA) is the FDA process of scientific and regulatory review to evaluate the safety and effectiveness of Class III medical devices. A Class III medical device is a device that supports or sustains human life, are of substantial importance in preventing impairment of human health, or which present a potential, unreasonable risk of illness or injury. Due to the level of risk associated with Class III devices, FDA has determined that general and special controls alone are insufficient to assure the safety and effectiveness of class III devices. The PMA process is the most stringent type of medical device marketing application required by FDA. The applicant must receive FDA approval of its PMA application prior to marketing the medical device for use with patients. PMA approval is based on a determination by FDA that the PMA contains sufficient valid scientific evidence to assure that the device is safe and effective for its intended use(s). An approved PMA is, in effect, a private license granting the applicant (or owner) permission to market the device. The PMA owner, however, can authorize use of its data by another. The PMA includes a clinical investigations section which describes the study protocols, safety and effectiveness data, adverse reactions and complications, device failures and replacements, patient information, patient complaints, tabulations of data from all individual subjects, results of statistical analyses, and any other information from the clinical investigations. Any investigation conducted under an Investigational Device Exemption (IDE) must be identified as such.

Currently there are several barriers that researchers face in conducting these trials including, recruiting geographically dispersed participants, preventing participant attrition, collecting real time data, ensuring adherence to medication, etc. Due to the stringent regulations and prevailing process, the clinical trial phases can, in some instances, take 10+ years, leading to a delay in access for patients as well as a delay in commercializing the investment in R&D that a company has made in the product. Consequently, the Go-to-Market process can be very time consuming and expensive. A median Phase III clinical trial study can have 50 investigator sites and cost about 25 Million USD over 2 years (about 35,000 USD/day).

Studies show that the contract research organizations serving the pharmaceutical industry generated revenues of USD 21.69 billion worldwide in 2010, Pharma Clinical Trial Services: World Market 2011-2021, published in July 2011. Industry is the primary driver of growth in spending on clinical research of investigational drugs and devices, accounting for 90% of total spending.

Current solutions for use in the clinical trial setting include, for example, U.S. Pat. No. 8,132,104 B2 issued Mar. 6, 2012, to Ash, et al. for Multi-Modal Entry for Electronic Clinical Documentation; U.S. Pat. No. 7,596,541 B1 issued Sep. 29, 2009, to deVries, et al., for Method and Apparatus of Assuring Informed Consent While Conducting Secure Clinical Trials; U.S. Pat. No. 7,251,609 B1 issued Jul. 31, 2007, to McAlindon et al., for Method for Conducting Clinical Trials Over the Internet; U.S. Publication US 2009/0313048 A1 published Dec. 17, 2009, to Kahn, et al. for Clinical Trials Management System and Method; and U.S. Publication US 2004/0093240 A1 to Shah, for Systems and Methods for Clinical Trials Information Management.

### SUMMARY OF THE INVENTION

The disclosure is directed to a process and system for managing the end-to-end process of conducting clinical trials including ‘Informed Consent’ and ‘Clinical Trial Data’. The process enables collection of appropriate informed consent from patient/participants via electronic devices such as smart phones and tablets. Additionally, the system uses biometric information such as fingerprint, face pictures, digital signature etc and system time stamp and GPS technology to provide additional information concerning a participant. This helps to make the whole informed consent process effortless, paperless and transparent. An aspect of the disclosure enables investigators to reach out to a wider patient/participant population irrespective of their physical location. Thus the platform enables investigators to collect and transfer real time data, seamlessly from across the world.

An additional aspect of the methods and systems is that it enables clinical trial for a participant/patient to be collected from a wide variety of locations, such as the convenience of their home which may greatly motivate potential participant/patients to sign up for trials and/or participate in studies, thereby reducing attrition in longitudinal studies. The product also enables researchers to promote treatment adherence of participants through electronic reminders and other features. Additional features can be included that facilitate effective data collection. Patient data can be reported by participants (from the convenience of their home) or recorded by doctors and researchers (from their research facilities/hospitals/health centers) around the world. An easy-to-use data collection interface enables investigator/researchers to have real-time access of participant data, stored in highly secured server environments.

Another aspect of the disclosure is directed to portable computing device platforms and system (such as smart phones and tablets) for enrolling participants in clinical research projects, obtaining informed consent from participants, and collecting data from the participants. The process includes providing information about the clinical trial process, providing study specific information, administering eligibility questions, obtaining one or more of biometric information and location information from a participant. Additionally, data can be captured from the patient directly, or devices associated with the patient, at a remote location and transmitted to the PI.

Still another aspect of the disclosure is directed to one or more computer storage media having computer executable instructions embodied thereof for performing a method in a to portable computing device platforms and system (such as smart phones ant tablets) for enrolling participants in clinical research projects, obtaining informed consent from participants, and collecting data from the participants. The process includes providing information about the clinical trial process, providing study specific information, administering eligibility questions, obtaining one or more of biometric information and location information from a participant. Additionally, data can be captured from the patient directly, or devices associated with the patient, at a remote location and transmitted to the PI.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which clinical trial data acquisition and management can be achieved;

FIG. 1B is a block diagram of an exemplary computing environment through which clinical trial data acquisition and management can be achieved;

FIG. 1C is an illustrative architectural diagram showing some structure that can be employed by devices through which clinical trial data acquisition and management is achieved;

FIG. 2 is an exemplary diagram of a server in an implementation suitable for use in a system where clinical trial data acquisition and management is achieved;

FIG. 3 is an exemplary diagram of a master system in an implementation suitable for use in a system where clinical trial data acquisition and management is achieved;

FIG. 4 is a block diagram showing the cooperation of exemplary components of a system suitable for use in a system where clinical trial data acquisition and management is achieved;

FIG. 5 illustrates a process for developing a new medication;

FIG. 6 illustrates mobile device screenshots and website interface screenshots;

FIG. 7 is a screenshot of a feature set with the clinical trial management system; and

FIG. 8 is a flow chart of the process.

### DETAILED DESCRIPTION OF THE INVENTION

### I. Computing Systems

The systems and methods described herein rely on a variety of computer systems, networks and/or digital devices for operation. In order to fully appreciate how the system operates an understanding of suitable computing systems is useful. The systems and methods disclosed herein are enabled as a result of application via a suitable computing system.

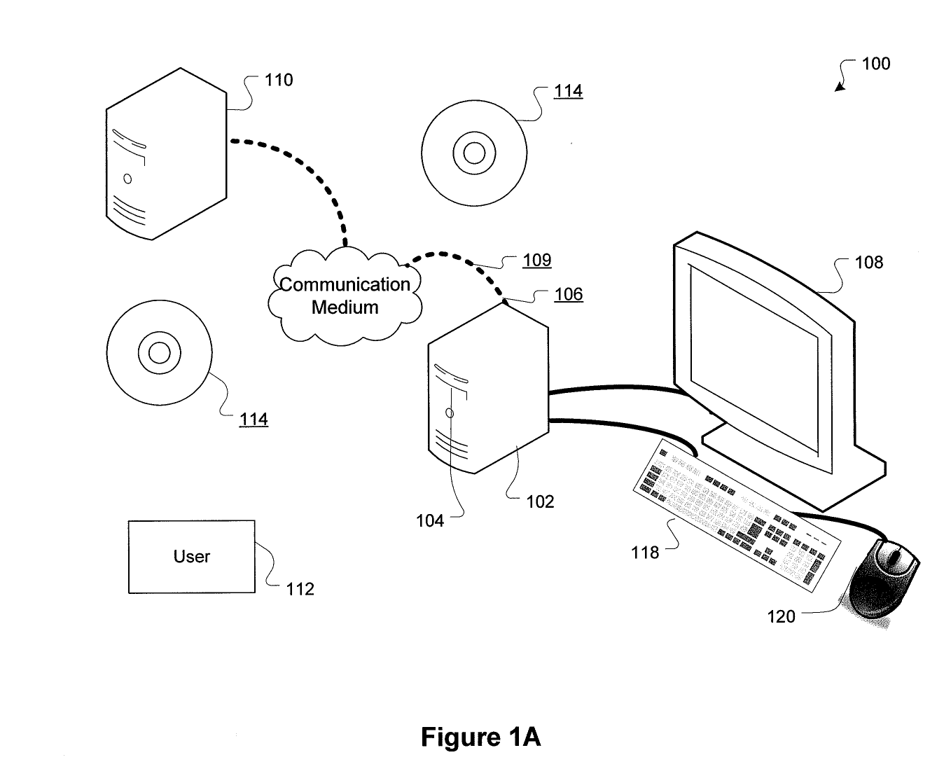

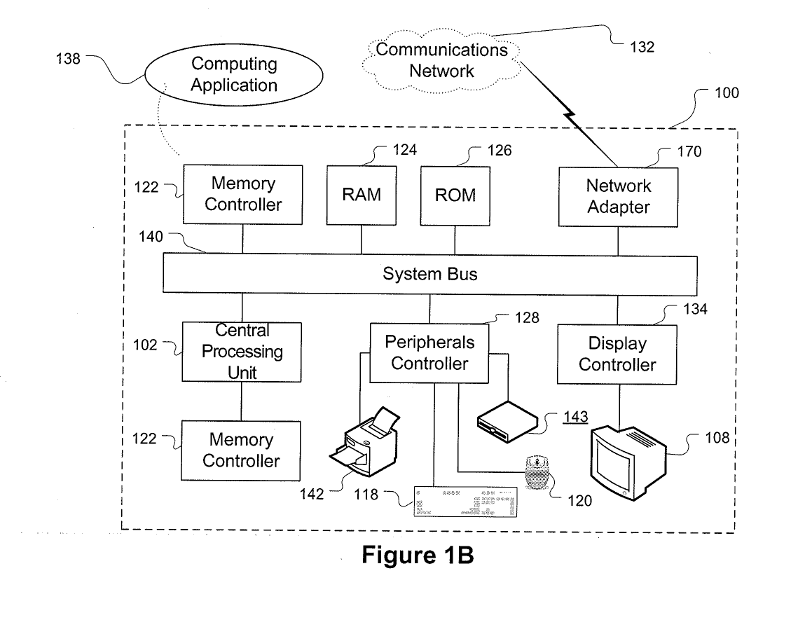

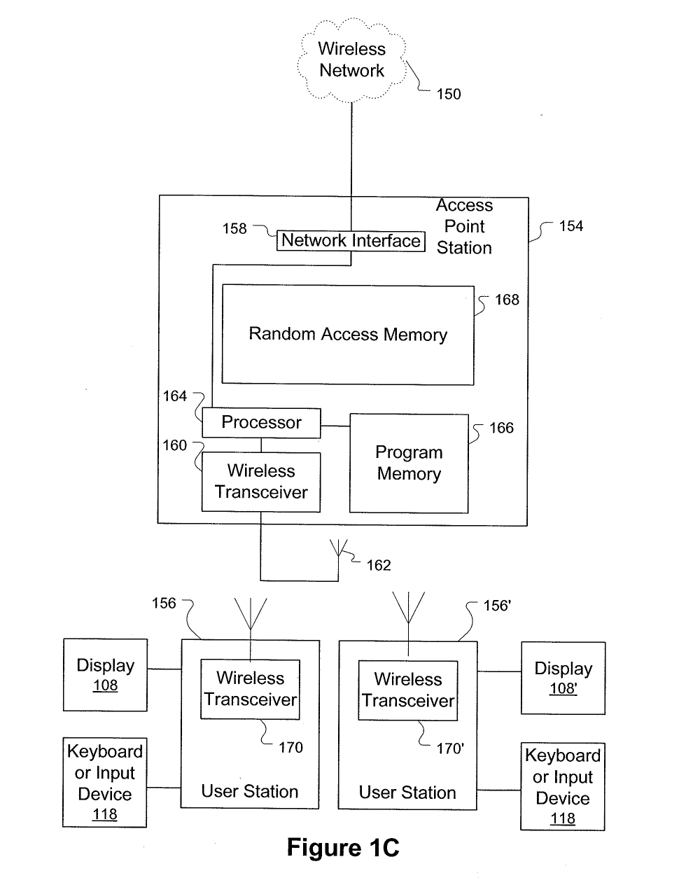

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and has a fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present invention can be transmitted over such networks or connections. The computer system can be adapted to communicate with a participant and/or a device used by a participant. The computer system is adaptable to communicate with other computers over the Internet, or with computers via a server.

FIG. 1B depicts another exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media adapted to tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some embodiments may be implemented in one or a combination of hardware, firmware and software. Embodiments may also be implemented as instructions stored on a non-transitory computer-readable storage medium, which may be read and executed by at least one processor to perform the operations described herein. A non-transitory computer-readable storage medium may include any mechanism for storing information in a form readable by a machine (e.g., a computer). For example, a non-transitory computer-readable storage medium may include read-only memory (ROM), random-access memory (RAM), magnetic disk storage media, optical storage media, flash-memory devices, and other non-transitory media.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, tablets etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), tablets, and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. In this document, the terminology “node” includes a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

FIG. 1C depicts components that can be employed in system configurations enabling the systems and technical effect of this invention, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

### IV. Media Independent Handover Services

In IEEE P802.21/D.01.09, September 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standard defines extensible media access independent mechanisms that enable the optimization of handovers between heterogeneous 802 systems and may facilitate handovers between 802 systems and cellular systems. “The scope of the IEEE 802.21 (Media Independent Handover) standard is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, September 2006, entitled Draft IEEE Standard for Local and Metropolitan Area Networks: Media Independent Handover Services, the entire contents of which document is incorporated herein into and as part of this patent application. Other IEEE, or other such standards on protocols can be relied on as appropriate or desirable.

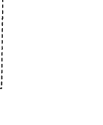

FIG. 2 is an exemplary diagram of a server 210 in an implementation consistent with the principles of the disclosure to achieve the desired technical effect and transformation. Server 210 may include a bus 240, a processor 202, a local memory 244, one or more optional input units 246, one or more optional output units 248, a communication interface 232, and a memory interface 222. Bus 240 may include one or more conductors that permit communication among the components of chunk server 250.

Processor 202 may include any type of conventional processor or microprocessor that interprets and executes instructions. Local memory 244 may include a random access memory (RAM) or another type of dynamic storage device that stores information and instructions for execution by processor 202 and/or a read only memory (ROM) or another type of static storage device that stores static information and instructions for use by processor 202.

Input unit 246 may include one or more conventional mechanisms that permit an operator to input information to a server 110, such as a keyboard 118, a mouse 120 (shown in FIG. 1), a pen, voice recognition and/or biometric mechanisms, etc. Output unit 248 may include one or more conventional mechanisms that output information to the operator, such as a display 134, a printer 130 (shown in FIG. 1), a speaker, etc. Communication interface 232 may include any transceiver-like mechanism that enables chunk server 250 to communicate with other devices and/or systems. For example, communication interface 232 may include mechanisms for communicating with master and clients.

Memory interface 222 may include a memory controller 122. Memory interface 222 may connect to one or more memory devices, such as one or more local disks 274, and control the reading and writing of chunk data to/from local disks 276. Memory interface 222 may access chunk data using a chunk handle and a byte range within that chunk.

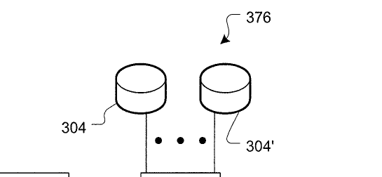

FIG. 3 is an exemplary diagram of a master system 376 suitable for use in an implementation consistent with the principles of the disclosure to achieve the desired technical effect and transformation. Master system 376 may include a bus 340, a processor 302, a main memory 344, a ROM 326, a storage device 378, one or more input devices 346, one or more output devices 348, and a communication interface 332. Bus 340 may include one or more conductors that permit communication among the components of master system 374.

Processor 302 may include any type of conventional processor or microprocessor that interprets and executes instructions. Main memory 344 may include a RAM or another type of dynamic storage device that stores information and instructions for execution by processor 302. ROM 326 may include a conventional ROM device or another type of static storage device that stores static information and instructions for use by processor 302. Storage device 378 may include a magnetic and/or optical recording medium and its corresponding drive. For example, storage device 378 may include one or more local disks that provide persistent storage.

Input devices 346 used to achieve the desired technical effect and transformation may include one or more conventional mechanisms that permit an operator to input information to the master system 374, such as a keyboard 118, a mouse 120, (shown in FIG. 1) a pen, voice recognition and/or biometric mechanisms, etc. Output devices 348 may include one or more conventional mechanisms that output information to the operator, including a display 108, a printer 142 (shown in FIG. 1), a speaker, etc. Communication interface 332 may include any transceiver-like mechanism that enables master system 374 to communicate with other devices and/or systems. For example, communication interface 332 may include mechanisms for communicating with servers and clients as shown above.

Master system 376 used to achieve the desired technical effect and transformation may maintain file system metadata within one or more computer readable mediums, such as main memory 344 and/or storage device.

The computer implemented system provides a storage and delivery base which allows users to exchange services and information openly on the Internet used to achieve the desired technical effect and transformation. A user will be enabled to operate as both a consumer and producer of any and all digital content or information through one or more master system servers.

A user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

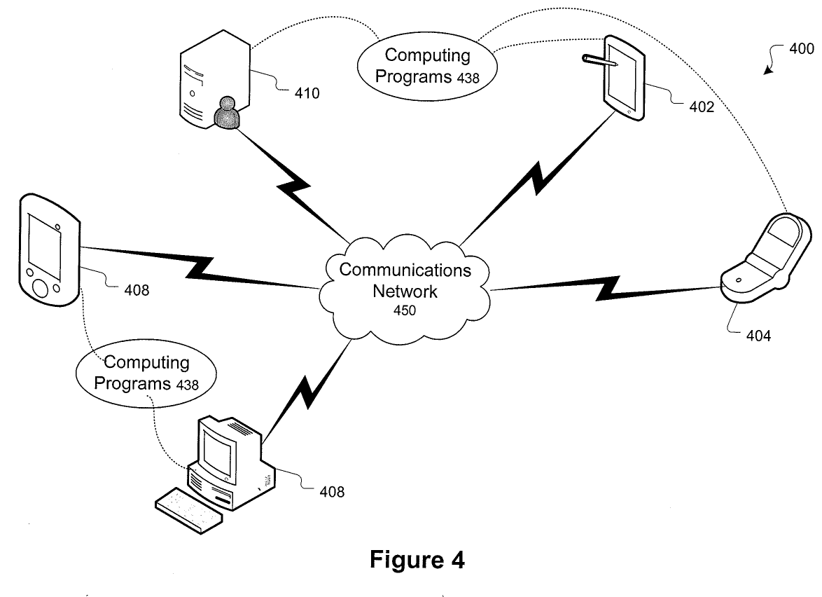

Computing system 100, described above, can be deployed as part of a computer network used to achieve the desired technical effect and transformation. In general, the above description for computing environments applies to both server computers and client computers deployed in a network environment. FIG. 4 illustrates an exemplary illustrative networked computing environment 400, with a server in communication with client computers via a communications network 450. As shown in FIG. 4, server 410 may be interconnected via a communications network 450 (which may be either of, or a combination of a fixed-wire or wireless LAN, WAN, intranet, extranet, peer-to-peer network, virtual private network, the Internet, or other communications network) with a number of client computing environments such as tablet personal computer 402, mobile telephone, smart phone 404, personal computer 402, and personal digital assistant 408. In a network environment in which the communications network 450 is the Internet, for example, server 410 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 400 can utilize various data security protocols such as secured socket layer (SSL) or pretty good privacy (PGP). Each client computing environment can be equipped with operating system 438 operable to support one or more computing applications, such as a web browser (not shown), or other graphical user interface (not shown), or a mobile desktop environment (not shown) to gain access to server computing environment 400.

In operation, a user (not shown) may interact with a computing application running on a client computing environment to obtain desired data and/or computing applications. The data and/or computing applications may be stored on server computing environment 400 and communicated to cooperating users through client computing environments over exemplary communications network 450. The computing applications, described in more detail below, are used to achieve the desired technical effect and transformation set forth. A participating user may request access to specific data and applications housed in whole or in part on server computing environment 400. These data may be communicated between client computing environments and server computing environments for processing and storage. Server computing environment 400 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VI. Media Independent Information Service

The Media Independent Information Service (MIIS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MIIS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MIIS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MIIS enables this functionality across all available access networks by providing a uniform way to retrieve heterogeneous network information in any geographical area.

### VII. Software Programs Implementable in the Computing and Network Environments to Achieve a Desired Technical Effect or Transformation

Disclosed is a system that enables investigators and researchers to identify and enroll patients, and to complete clinical trials investigations faster, and make the data transfer and analysis seamless. The system also reduces the cost of clinical trials by providing efficient tools and processes for acquiring patient data and processing patient data. This also enables the researcher/investigator to leverage the latest technology, via use of smart phones, tablets, cloud, security, and also increase transparency. The system and methods also provide a platform to enable researchers to reach out to a wider audience or potential patients/participants, far away from the research location. Clinical trials market now witnesses a paradigm shift. Heterogeneous patient populations in the developing nations are opening up new avenues for the clinical trials market. Developing countries also offer faster means; which is triggering major pharmaceutical companies to direct their investment in these regions. Apart from this, stringent regulations and tight R&D budgets in the pharma-biotech industry are also forcing companies to move to east.

FIG. 4 is a block diagram showing the cooperation of exemplary components of a system suitable for use in a system where clinical trial data acquisition and management is achieved. A significant, labor intensive, and time consuming component of enrolling patients in a clinical trial relates to identifying eligible patients within a geographic area that is supportable by the principal investigator (PI) and the PIs team that fall within the criteria identified for the clinical trial. Once the patients are identified, then time is spent explaining the clinical trial to the patient and obtaining the patient's informed consent. Suitable patients may exist outside the geographic area, who are excluded solely because of geography and inability to work with them. This results in the enrollment process taking a long time and, for rarer conditions, may result in difficulty achieving enrollment numbers. By leveraging off of a communication network 450 which can be cloud based, a potential patient or a remote investigator can using a mobile computing devices such as a smart phone 408, or a tablet 402 to obtain general information about the clinical trial. General information can be written information and/or video and/or audio information which explains what the clinical trial is about. Additional components can be provided that enable the patient to obtain additional information about aspects that may not be clear to that patient, while enabling another patient to forego reviewing the information.

For example, in the case of a clinical trial relating to idiopathic transverse spinal myelitis (which has a peak incidence rate of 1400 cases per year), general information could be provided about the clinical trial, but for potential participants that wanted more information about causes for transverse myelitis, that additional information could be available with an optional selection.

Additionally, the potential participant could use the mobile computing device to enroll in the clinical trial. Confirmation of the identity of the participant and their location can be confirmed using, for example, biometric and GPS capabilities in the mobile computing devices. As the informed consent is obtained from the patient, specific information is provided. As with the general information, as necessary, additional information can be made available to the participant as they work through the process. A biometric consent process is included that provides obtaining one or more pieces of biometric information (photograph, fingerprint, digital signature, etc.).

An additional aspect of the process is the ability to monitor progress of the participant remotely. This process can include providing calendar events on the mobile computing device that pings the participant with questions or requests for input at an interval proposed by the clinical trial protocol. This information can be collected directly from the participant with confirmation of the participant's identity by using the biometric data previously provided.

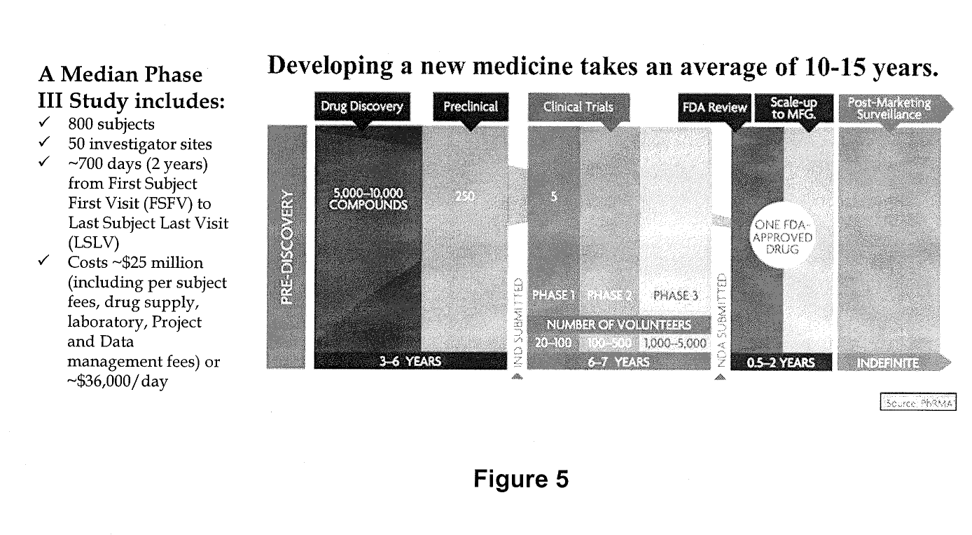

FIG. 5 illustrates a process for developing a new medication. A median Phase III clinical trial study includes, on average, ˜800 patients, ˜50 investigator sites, takes ˜700 days (on average 2 years) from the first subject visit to the last subject visit, and costs ˜25M USD. The cost includes per subject fees, drug supply, laboratory, project and data management fees. Additionally, data must be managed in such a way that an audit of the information can be easily performed. The new medication process is comprised of several steps. During pre-discovery, 5000-10000 compounds are processed during a drug discovery phase. From that initial process, 250 compounds are advanced to a preclinical evaluation. This pre-discovery process takes 3-6 years. From that stage, about 5 compounds have an IND submitted and enter the Clinical Trial phase and are processed through the three phases of the clinical trial process, which takes an additional 6-7 years. Thereafter an NDA is submitted which typically results in one compound being approved in another 6 months to 2 years.

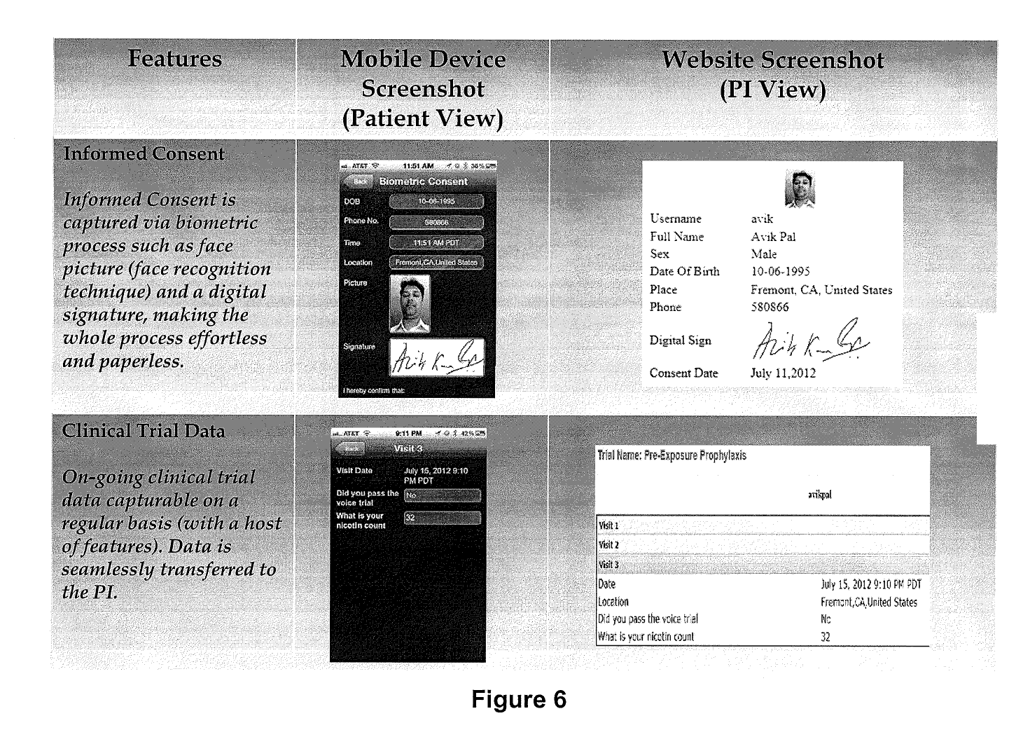

FIG. 6 illustrates mobile device screenshots and website interface screenshots. The systems and processes include a mobile device (e.g., smart phone or tablet) interface with a confirmation/authentication screen which provides, for example, biometric information for processing as well as patient information, such as date of birth (DOB), phone number, government ID information, time, location (e.g., gleaned from a GPS system), device ID information, a picture, and a signature. Additional biometric information can be obtained (e.g., fingerprint or retinal scan). On the PI side, the data is captured and transferred to the PI.

As the clinical trial is conducted, on-going clinical trial data is capturable on a regular basis with additional feature functionality and data is transferred seamlessly to the PI.

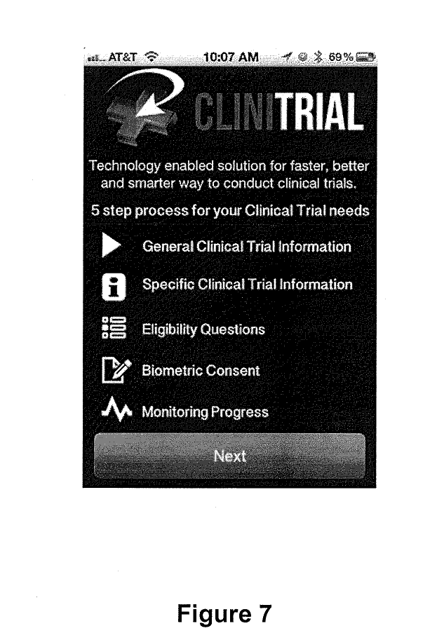

FIG. 7 is a screenshot of a feature set with the clinical trial management system from a home screen on a mobile computing device such as a smart phone.

At the General Info tab: information explaining the clinical trial to a potential participant is provided. The information can be text, audio, visual, or a combination thereof. The General Info materials are configurable to assist the ‘subject’ in making an informed decision whether s/he wants to participate in a clinical trial or not. A video can be provided that is generic and usable across a plurality of clinical trials, and covers most standard information.

At the Specific Info tab: information is provided that provides additional details specific to a particular ‘Clinical Trial’ research project that the subject has chosen or is considering participating in. Going through this section will help him/her decide whether or not this trial is right for him/her.

At the Eligibility Questions tab: a questionnaire is provided, that captures the subject's response to specific questions and criteria study participants must meet in order to participate. This information assists the PI in deciding whether the subject is eligible for this research. Additionally, a log can be maintained of the potential subject's answers to the questionnaire along with other data to identify attempts of a potential participant to gain entry into a clinical trial by resubmitting questionnaires in an effort to achieve qualification.

At the Biometric Consent tab: biometric information is captured along with consent (including face picture/fingerprint/digital signature etc), confirming his/her acceptance as a participant in the trial.

At the Monitoring Progress tab: Data that is either capturable by the participant without necessarily travelling to the PI's facility is collected and entered by the subject following the study protocol, or by the PI at the study facility. Collected data is specified by the requirements for the research protocol and can include calendaring and reminders for the participant. Additional feedback mechanisms can be provided to ensure accurate data as well as showing positive changes.

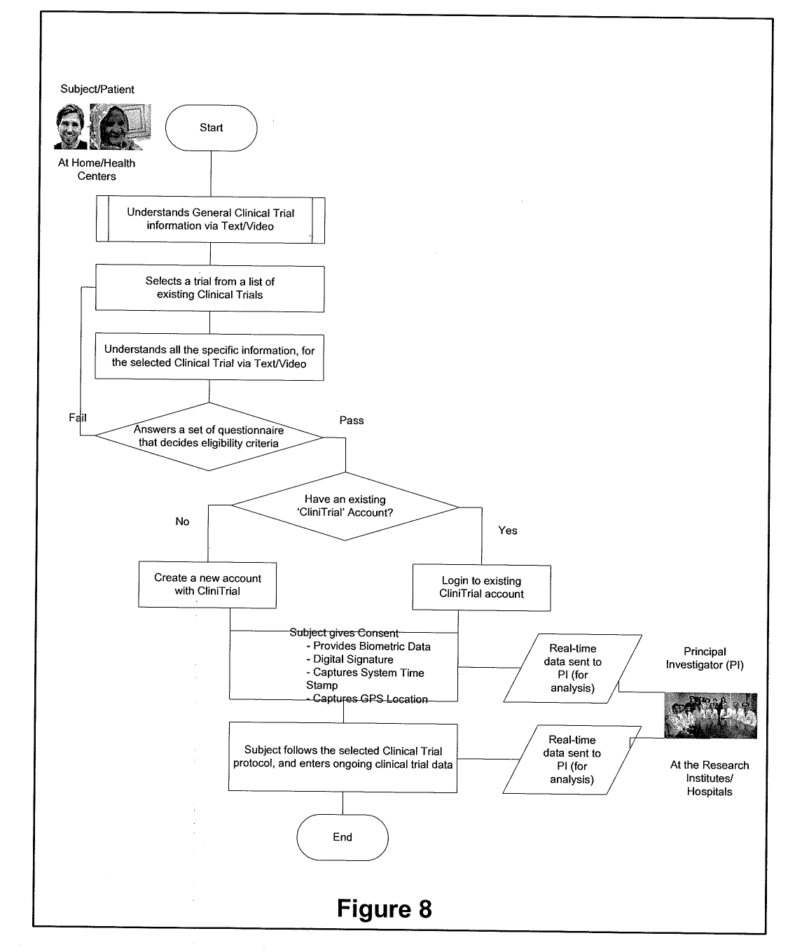

FIG. 8 is a flow chart of the process. A participant or patient at home or in a healthcare center remote from the PI begins the process and confirms that s/he understands the general clinical trial information provided. The participant may be given a list of clinical trials to select from. Thereafter, the patient may review specific information or the particular clinical trial. Thereafter, the patient answers a plurality of questions to determine whether s/he is eligible to participate in the clinical trial. If the patient fails a questionnaire for a particular clinical trial, the patient may be given the opportunity to select other clinical trials. If the answers establish that the patient is eligible to participate in the clinical trial, then the user will be asked to log into the system or to complete a new account. As will be appreciated by those skilled in the art, the patient can be asked to login or set up an account earlier in the process in order to prevent multiples attempts by one participant to gain entry into a clinical trial (e.g., by changing answers). Once the patient is logged in (or sets up an account with biometric information), the subject reviews the informed consent information and provides consent to be enrolled in the trial (or declines consent, in which case enrollment will not proceed). The eligibility information and consent is then sent to the PI for analysis. The subject then participants in the clinical trial protocol and enters ongoing clinical trial data which is sent to the PI for analysis on an ongoing basis.

In another configuration, the eligibility information can be sent to the PI prior to obtaining consent from the patient. In that configuration, the PI would review the eligibility information and then make a determination whether to include the patient. Once a determination is made that the patient is eligible, the patient would then receive a message welcoming him/her to the clinical trial and a request that s/he review the informed consent information prior to proceeding. Once the consent is obtained, then the subject would follow the clinical trial protocol.

The application can be offered as a cloud-based application for data capture, storage and retrieval. In simple terms, the data collected by the subjects can be pushed to a secured server in the cloud and then easily accessed by the PI via the secured website. Therefore, the PIs can manage the entire data collection process without the need to maintain costly hardware and software in-house and employing IT staff to manage them. All the data resides on the central server and is protected by SSL (Secure-Socket Layer) encryption technology.

Additionally, it is contemplated that the system is configurable to integrate medical devices with the application installed on mobile devices (e.g. iPhone®, iPad®, Android® etc). Once the integration is in place, the system can capture data from various biomedical instruments such as digital blood pressure instrument, glucometer, ECG etc, as and when needed as part of the research. This set of information is then captured in the subject's visit profiles, and directly fed to the application, which is then accessed by the PI (principal Investigators) sitting at the research center. This integration automates the data collection process and eliminates any manual input of data into the system. Additionally, medical devices with onboard communication capability can transmit information wirelessly to the system as well.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for use in clinical trial,
wherein a mobile device is used for registration process of a subject for said clinical trial,
wherein a biometric consent process is included that provides obtaining one or more pieces of biometric information via said mobile device,
wherein the subject is able to provide a signature on said mobile device, that generates a signed informed consent form, and
wherein said informed consent form is mapped directly to the said subject's profile.

2. A system as in claim 1, wherein said mobile device is a smartphone, tablet, kindle, or any other hand-held device.

3. A system as in claim 1, wherein said mobile device runs on a operating system such as iOS, Android, Windows, Blackberry.

4. A system as in claim 1, wherein said one or more pieces of biometrics is captured in a form such as photograph, fingerprint, digital signature.

5. A system as in claim 1, wherein said subject uses said mobile computing device to confirm their location of registration via location capabilities allowed by said mobile computing device.

6. A system as in claim 1,
wherein as part of the registration process, general information explaining the clinical trial is provided to said subject.
wherein said general information is text, audio, visual, or a combination thereof.
wherein said general information materials are configurable to assist said subject in making an informed decision whether said subject wants to participate in said clinical trial,
wherein a video is provided that is generic and usable across a plurality of clinical trials, and covers most standard information.

7. A system as in claim 1, wherein as part of the registration process, specific information is provided with additional details specific to said clinical trial, that said subject has chosen or is considering participating in.

8. A system as in claim 1, wherein a questionnaire is provided, that captures said subject's response to specific questions and criteria that said subjects must meet in order to participate, wherein in addition, a log is maintained of the said subject's answers to the questionnaire along with data to identify failed attempts of said subject to gain entry into a clinical trial by resubmitting questionnaires in an effort to achieve qualification.

9. A system for use in clinical trial,
wherein said system is able to capture subject data and monitor progress remotely, on an ongoing basis throughout the duration of a clinical trial,
wherein said subject data is collected directly from said subject with verification of the said subject's identity,
wherein said system enables data flow management between the study sites, said subjects and the investigators.
wherein said subject data is captured directly into a mobile device.

10. A system as in claim 9, wherein said mobile device is not connected to internet, or a data server, while acquiring data from said subject, and is able to transmit data to said data server when a connection is established.

11. A system as in claim 9, wherein calendar events can be setup on the mobile computing device that pings said subject with questions, requests for input, or sends reminders at an interval proposed by the clinical trial protocol.

12. A system as in claim 9, wherein on-going clinical trial data is captured on a regular basis with additional feature functionality and data is transferred seamlessly to said investigator.

13. A system as in claim 10, wherein the said data server is a cloud-based application used for data capture, storage and retrieval.

14. A system for use in clinical trial,
wherein said system is configurable to allow a mobile device to integrate subject data captured from medical devices,
wherein said subject data is stored in said subject's visit profile, and directly fed to a cloud-based server,
wherein said subject data is seamlessly accessed by investigators.

15. A system as in claim 14, wherein said mobile device captures said subject data through a electronic communication port from said medical devices,

16. A system as in claim 14, wherein said electronic communication port is a USB, Bluetooth, or other data transmission modes.

17. A system as in claim 14, wherein said medical device is a digital blood pressure instrument, glucometer, EKG, digital thermometer, blood analyzer or urine analyzer.
